(19) United States
(12) Patent Application Publication
(10) Pub. No.: US 2007/0232131 A1
(43) Pub. Date: Oct. 4, 2007

(54) Electrical connector set

(75) Inventor: Ted Ju, Keelung (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Lotes Co., Ltd.

(21) Appl. No.: 11/375,394

(22) Filed: Mar. 15, 2006

(51) Int. Cl. H01R 13/66

(52) U.S. Cl. 439/541.5

(57) ABSTRACT

An electrical connector set is disclosed to include a base frame, a first electrical connector and a second electrical connector mounted in the base framed at different elevations, and a plurality of retaining devices for securing the electrical connector set to a circuit board, each retaining device having an integral first retaining portion and an integral second retaining portion respectively fastened to the base frame.

### BACKGROUND OF THE INVENTION

1. Field of the Invention

The present invention relates to electrical connectors and more particularly, to an electrical connector set.

2. Description of the Related Art

A conventional electrical connector set is known comprising a base frame, a first electrical connector and a second electrical connector mounted in the base frame, fastening devices for securing the electrical connector set to a circuit board, and bottom plate that secures the end portions of the terminals of the first electrical connector and the second electrical connector. The fastening devices each are comprised of a first fastening member and a second fastening member. The first fastening member is symmetrically fastened to retaining grooves at upright supports of the base frame. The second fastening member is fastened to the bottom plate. The first fastening member, the second fastening member and the bottom plate constitute a triangular configuration. According to this design, the first fastening member and second fastening member of each fastening device are two separated members. This design complicates the installation procedure of the electrical connector set, and also relatively increases the cost.

### SUMMARY OF THE INVENTION

The present invention has been accomplished under the circumstances in view. It is the main object of the present invention to provide an electrical connector set, which is easy to install.

To achieve this and other objects of the present invention, the electrical connector set comprises a base frame, a first electrical connector and a second electrical connector mounted in the base framed at different elevations, and at least one retaining device adapted to secure the electrical connector set to a circuit board. The at least one retaining device each has an integral first retaining portion and an integral second retaining portion respectively connectable to the base frame.

### BRIEF DESCRIPTION OF THE DRAWINGS

FIG. 1 is an exploded view of an electrical connector set according to the present invention.

FIG. 2 is an oblique top elevational assembly view of the electrical connector set according to the present invention.

FIG. 3 is a rear elevational assembly view of the electrical connector set according to the present invention.

FIG. 4 is an oblique rear elevation of the base frame for the electrical connector set according to the present invention.

FIG. 5 is an oblique front elevation of the base frame for the electrical connector set according to the present invention.

FIG. 6 is an oblique rear elevation of the first electrical connector for the electrical connector set according to the present invention.

FIG. 7 is an oblique elevation of a part of the present invention, showing the electrical connector and the second electrical connector installed in the base frame.

FIG. 8 is an oblique elevation showing the retaining devices installed in the base frame according to the present invention.

FIG. 9 is an elevational view of one retaining device for the electrical connector set according to the present invention.

### DETAILED DESCRIPTION OF THE INVENTION

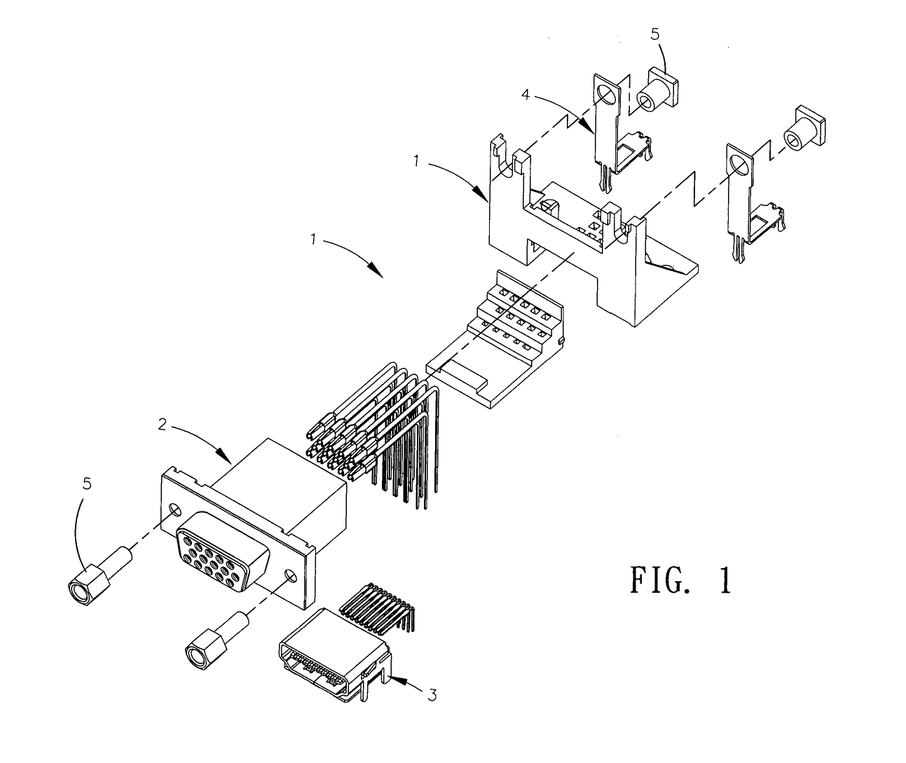

Referring to FIGS. 1˜9, an electrical connector set in accordance with the present invention is shown comprising a base frame 1, a first electrical connector 2 and a second electrical connector 3 arranged in a stack on the base frame 1, and two retaining devices 4 that secure the electrical connector set to a circuit board (not shown).

The base frame 1 has a substantially H-shaped profile when viewed from the front side, or a L-shaped profile when viewed from one lateral side. The base frame 1 has a flat base 13, two upright supports 11 perpendicularly upwardly extending from the flat base 13 and arranged in parallel, and a transverse connecting portion 12 connected between the two upright supports 11. The upright supports 11 each have a U-shaped top notch 111, and at least one, for example, two protruding blocks 112 disposed at two sides of the U-shaped top notch 111 respectively engaged into a respective groove 211 on the electrically insulative housing 21 of the first electrical connector 2. The base frame 1 further defines a top receiving space 121 between the two upright supports 11 above the transverse connecting portion 12 for accommodating the first electrical connector 2, and a bottom receiving space 122 between the two upright supports 11 below the transverse connecting portion 12 for accommodating the second electrical connector 3. The base frame 1 has a plurality of locating grooves 131, at least one first through hole 132, and at least one second through hole 133. According to this embodiment, the base frame 1 has one first through hole 132 and one second through hole 133.

The retaining devices 4 have a substantially L-shaped profile when viewed from one lateral side. Each retaining device 4 has a first retaining portion 41, a second retaining portion 42, a vertical wall 43, and a horizontal wall 44. The first retaining portion 41 extends vertically downwardly from the bottom side of the vertical wall 43. The second retaining portion 41 extends vertically downwardly from one end of the horizontal wall 44 remote from the vertical wall 43. The first retaining portion 41 and the second retaining portion 42 are respectively engaged into the first through hole 132 and the second through hole 133. The horizontal wall 44 is engaged into the locating grooves 131 to prohibit the respective retaining device 4 from vertical displacement relative to the base frame 1.

During installation, the first electrical connector 2 and the second electrical connector 3 are respectively mounted in the top receiving space 121 and the bottom receiving space 122, and then the retaining devices 4 are respectively mounted in the base frame 1 to force the first retaining portion 41 and the second retaining portion 42 into the first through hole 132 and the second through hole 133 respectively and to engage the horizontal wall 44 into the locating grooves 131 to prohibit the respective retaining device 4 from vertical displacement relative to the base frame 1, and then fasteners (for example, screws) 5 are used to affix the first electrical connector 2 and the retaining devices 4 to the U-shaped top notches 111 of the base frame 1, and therefore the electrical connector set is assembled.

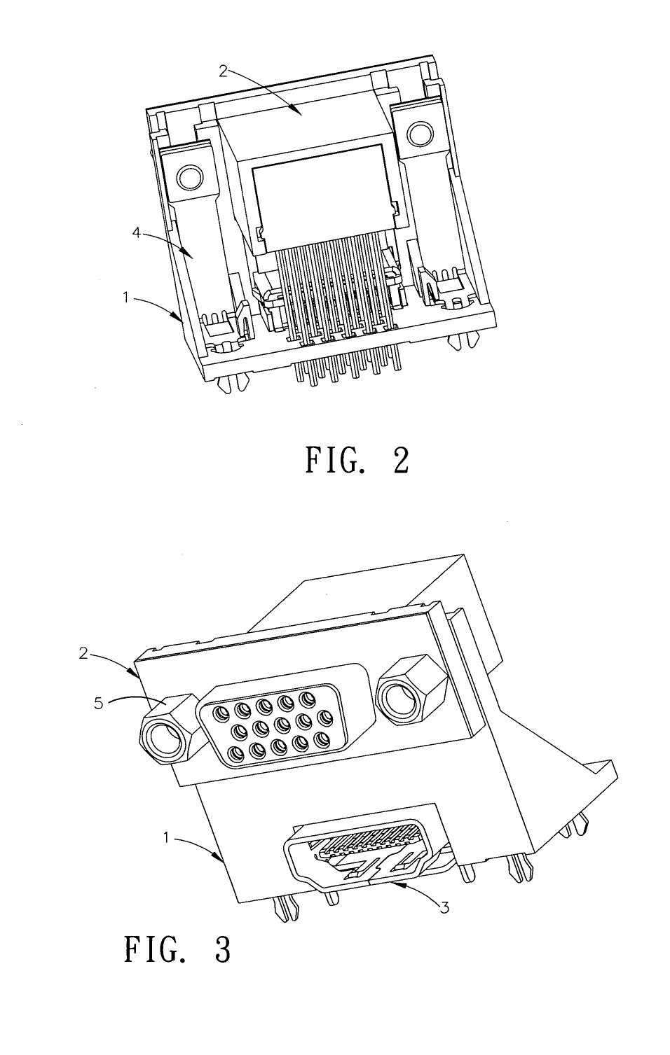

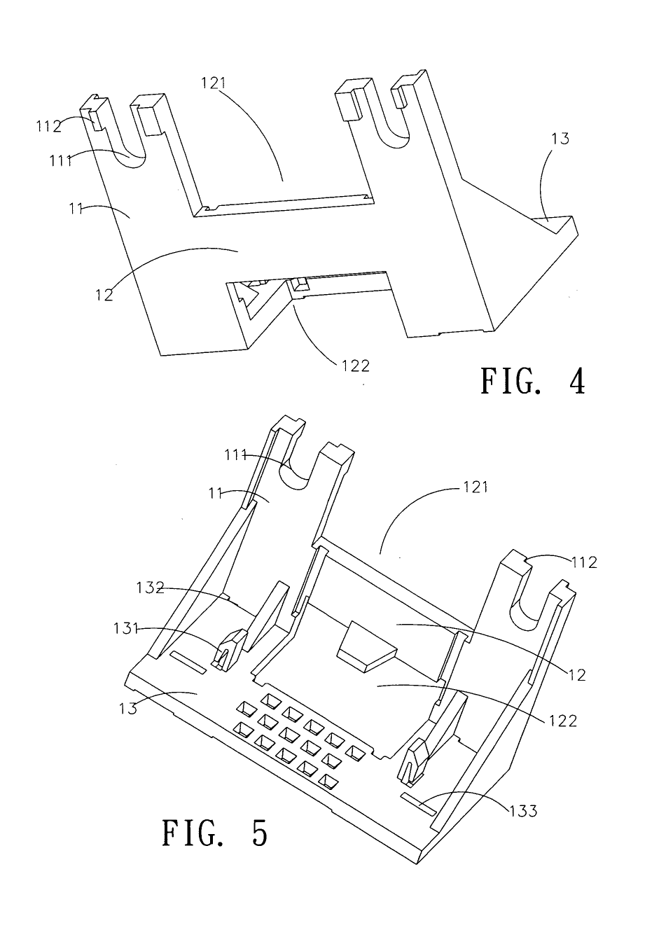

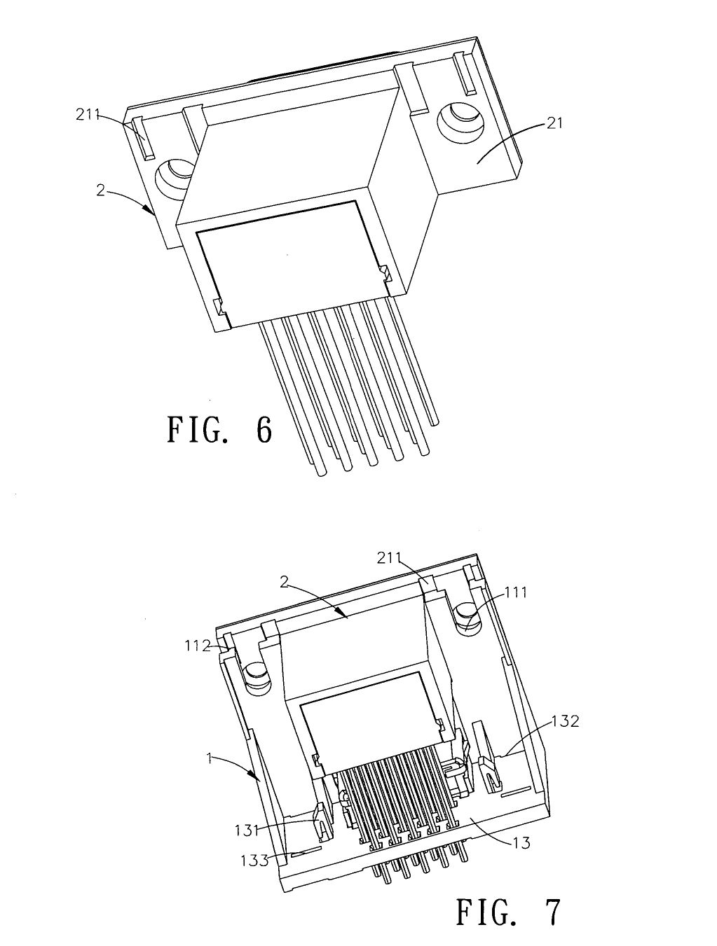

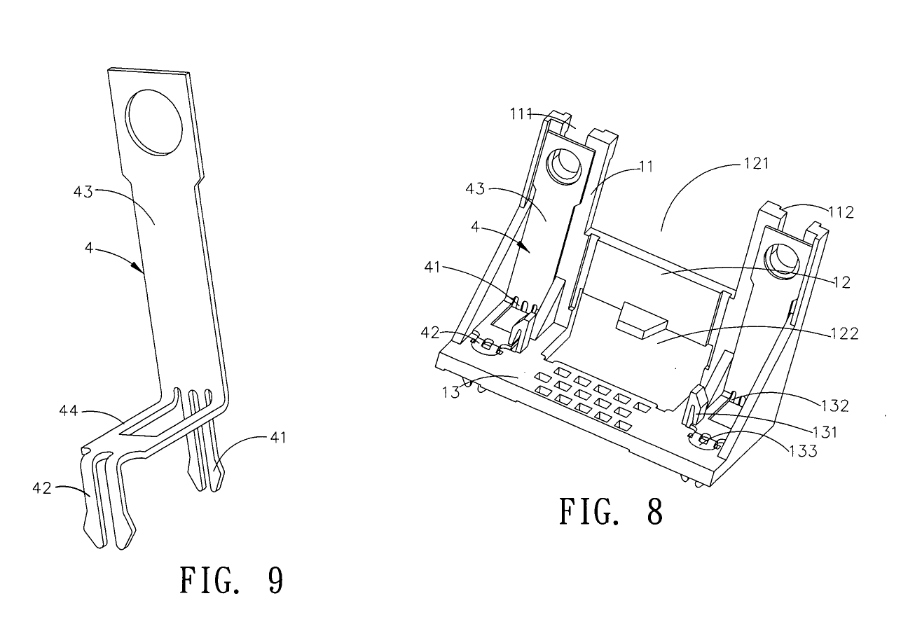

A prototype of electrical connector set has been constructed with the features of FIGS. 1-9. The electrical connector set functions smoothly to provide all of the features discussed earlier

Although a particular embodiment of the invention has been described in detail for purposes of illustration, various modifications and enhancements may be made without departing from the spirit and scope of the invention. Accordingly, the invention is not to be limited except as by the appended claims.

1. An electrical connector set comprising a base frame, a first electrical connector and a second electrical connector mounted in said base framed at different elevations, and at least one retaining device adapted to secure the electrical connector set to a circuit board, wherein said at least one retaining device each has an integral first retaining portion and an integral second retaining portion respectively to both connect to and extend through said base frame to connect with a circuit board, wherein the first retaining portion is located to be parallel to the second retaining portion, wherein said at least one retaining device each have a horizontal wall and a vertical wall, showing a L-shaped profile, said horizontal wall being configured to be parallel to the circuit board when connected to the circuit board.

2. (canceled)

3. The electrical connector set as claimed in claim 2, wherein said first retaining portion is vertically downwardly extending from a bottom side of the vertical wall of the respective retaining device.

4. The electrical connector set as claimed in claim 2, wherein said second retaining portion is vertically downwardly extending from one end of the horizontal wall of the respective retaining device remote from the vertical wall of the respective retaining device.

5. The electrical connector set as claimed in claim 1, wherein said base frame has a flat base, said flat base has at least one locating groove for receiving the horizontal wall of each of said at least one retaining device to prohibit said at least one retaining device from vertical displacement relative to said base frame.

6. The electrical connector set as claimed in claim 1, wherein said base frame further has two upright supports respectively upwardly extending from said flat base for supporting said at least one retaining device.

7. The electrical connector set as claimed in claim 6, wherein said upright supports each have a U-shaped top notch for the mounting of a respective fastening device to affix said first electrical connector to said base frame.

8. The electrical connector set as claimed in claim 6, wherein said upright supports each have at least one protruding block; said first electrical connector has a plurality of grooves respectively forced into engagement with the at least one protruding block of said upright supports.

9. The electrical connector set as claimed in claim 6, wherein said base frame further has a transverse connecting portion connected between said two upright supports, said transverse connecting portion defining with said upright supports a top receiving space and a bottom receiving space.

10. The electrical connector set as claimed in claim 9, wherein said first electrical connector and said second electrical connector are respectively mounted in said top receiving space and said bottom receiving space.
